(19) United States
(12) Patent Application Publication
(10) Pub. No.: US 2002/0083608 A1
(43) Pub. Date: Jul. 4, 2002

(54) Measuring tools and method for performing measurements in mating machine parts

(76) Inventor: Joseph Stephens, Peachtree City, GA (US)

Correspondence Address: BIRCH STEWART KOLASCH & BIRCH, PO BOX 747, FALLS CHURCH, VA, 22040-0747, US

(21) Appl. No.: 09/972,857

(22) Filed: Oct. 10, 2001

Related U.S. Application Data
(60) Provisional application No. 60/238,468, filed on Oct. 10, 2000.

(51) Int. Cl. G01B 5/20

(52) U.S. Cl. 33/555; 33/833

(57) ABSTRACT

The disclosed tools and method perform measurements of bore parallelism and location in mating machine parts.

One of the tools, used to perform measurements on bores in a machine part, includes two platforms separated by risers. The lower of the two platforms has a surface that mimics the mounting surface of a mating machine part. Spindle assemblies mounted on the upper platform are located in precise correspondence with the blue print locations of side-by-side bores in one of the mating machine parts. Each of the spindle assemblies comprises a hollow column receiving a rotatable spindle that carries a dial indicator at its lower end. To perform measurements on the machine part, it is fastened to the underside of the lower platform, and the movable probe of the dial indicator engaging one of the bores, a sweep of the feeler about the bore is performed by turning the spindle.

Another tool includes a base with a surface that mimics the mounting flange of a machine part. Carried on the base is a spindle assembly located in precise correspondence with the blue print position of a bore in a mating machine part. With the base of the tool fastened to mounting pad on the mating machine part, the movable probe of a dial indicator fastened to the spindle assembly is swept about a bore in the mating machine part to perform measurements of the location and orientation of the bore.

### CROSS-REFERENCE TO RELATED APPLICATIONS

This application claims the benefit of U.S. Provisional Application No. 60/238,468, filed Oct. 10, 2000, the entire disclosure of which is hereby incorporated by reference.

### BACKGROUND OF THE INVENTION

1. Field of the Invention

The present invention relates to tools and to a method for performing measurements in machine parts. More particularly, the present invention relates to tools and a method for performing measurements to determine deviations from specification of bores and machine elements in mating machine parts. The tools and method disclosed herein may, for example, be used to perform measurements of the bores in the main gear box internal scavenge pump and in the main gearbox case of a jet aircraft engine used on commercial airliners. The tools and method disclosed herein may, for example, also be used for measuring the gear backlash of a gear in the scavenge pump.

2. Background Information

In the ordinary service of a machine, the various assemblies and parts are subjected to stresses from internal and external forces and, particularly with internal combustion engines, cycles of heating and cooling. These stresses cause not just normal wear of the assemblies and parts but also unacceptable distortion and migration of surfaces including bores that accommodate bearings and shafts. In an assembly having mating parts, where, for example, a shaft supported in one of the parts provides a drive for a shaft supported in the other part, the location, orientation and dimensions of bores in the mating parts within close tolerances can be critical to satisfactory performance. This is particularly true of the above-noted scavenge pump and main gearbox case of an aircraft engine.

In normal service of the engine, deviation of the location and parallelism of bores in the scavenge pump and in the gearbox case, and of gear backlash in the scavenge pump, from their blueprint specifications is a common occurrence. If, however, the deviations are outside of acceptable tolerances, excessive wear of the bearings, shafts and gears in the case-pump assembly can occur. Excessive wear adversely affects the performance of the pump and can result in failure of the pump. Performing measurements of the bores in the pump and in the case, and of gear backlash in the scavenge pump, to determine whether the specifications for these elements are within acceptable tolerances has entailed time-consuming and costly procedures, including removal and disassembly of the gearbox and transport of the pump and the gearbox to a remote site for evaluation. Obviously, it would be desirable to be able to perform measurements on the pump and the gearbox onsite, where the time and expense of the procedure would be significantly reduced.

Tools for measuring the location, roundness, orientation and/or parallelism of bores and shafts in machines are known. Disclosures of measuring tools for these purposes are found, for example, in U.S. Pat. Nos. 1,048,078, 1,241,469, 2,400,293, 2,456,003, 3,254,416, 4,080,741, 4,222,173, 4,338,726, 4,412,385, 4,439,925 and 4,509,267. The measuring tools disclosed in these patents do not, however, lend themselves particularly well to measuring, for example, the location, dimensions and orientation of bores in a machine part vis-à-vis bores or surfaces of a mating machine part.

### BRIEF SUMMARY OF THE INVENTION

The tools and method of the present invention achieve several objects and advantages. These tools and method facilitate the performance of precise measurements of machine parts in less time and at lower cost than when using known measuring tools and methods. A particular advantage of using the tools and method of the present invention is that the locations, orientations and dimensions of the machine parts can be performed as the parts relate to each other in an assembly. As used in performing measurements on parts of a jet aircraft engine, the tools and method of the present invention, allow the measurements to be made more reliably, with less down time for the engine, and at considerably less expense. Some of the measurements performed by the tools and method of the present invention can be performed on the engine underwing, a practice that has not been feasible using known measuring tools and methods.

Objects and advantages of the present invention are achieved by a measuring tool for performing measurements on a first machine part having a mounting surface that mates with a mounting surface of a cooperating machine part, the tool comprising: a mounting surface that (1) mimics the mounting surface of the cooperating machine part and (2) has an opening therethrough, whereby the tool can be joined to the first machine part in a position that corresponds to the position of the cooperating machine part when mated with the first machine part, while permitting access to the first machine part; a spindle assembly including a rotatable spindle shaft that extends toward the opening through the mounting surface of the tool at a location, and at an orientation, corresponding to a desired location and orientation of an element in the first machine part; and a measuring instrument carried on the spindle shaft, the measuring instrument having a movable probe and an indicator responsive to deviations in the position of the probe from a reference position, whereby turning of the spindle shaft with the probe engaging a surface of the element in the first machine part will provide an indication of deviations of the location, orientation and dimensions of the element from desired values for location, orientation and dimensions of the element.

Objects and advantages of the present invention are also achieved by a measuring tool for performing measurements on a first machine part having (1) a mounting surface that mates with a mounting surface of a cooperating machine part and (2) a plurality of side-by-side bores accessible through the mounting surface of the first machine part, the tool comprising: a mounting surface that (1) mimics the mounting surface of the cooperating machine part and (2) has an opening therethrough, whereby the tool can be joined to the first machine part in a position that corresponds to the position of the cooperating machine part when mated with the first machine part, while permitting access to the bore in the first machine part; a plurality of spindle assemblies, each of the spindle assemblies including a rotatable spindle shaft that extends toward the opening through the mounting surface of the tool at a location, and at an orientation, corresponding to a desired location and orientation of a bore in the first machine part; and a measuring instrument carried on at least one of the spindle shafts, the measuring instrument having a movable probe and an indicator responsive to deviations in the position of the probe from a reference position, whereby turning of the spindle shaft with the probe engaging the interior surface of a bore in the first machine part will provide an indication of deviations of the location, orientation and roundness of the bore from desired values for location, orientation and roundness of the bore.

Objects and advantages of the present invention are also achieved by a method of performing measurements on a first machine part having a mounting surface that mates with a mounting surface of a cooperating machine part, the method comprising the steps of: joining a measuring tool to the first machine part in a position that corresponds to the position of the cooperating machine part when mated with the first machine part, the measuring tool including a spindle assembly including (1) a rotatable spindle shaft that extends toward the mounting surface of the tool at a location, and at an orientation, corresponding to a desired location and orientation of an element in the first machine part and (2) a measuring instrument carried on the spindle shaft, the measuring instrument having a movable probe and an indicator responsive to deviations in the position of the probe from a reference position; and turning the spindle shaft with the probe engaging a surface of the element in the first machine part to thereby obtain an indication of deviations of the location, orientation and dimensions of the element from desired values for location, orientation and dimensions of the element.

The comprehensive scope and applicability of the present invention will become apparent from the detailed description provided below. It should be understood, however, that the detailed description and specific examples, as they relate to preferred embodiments of the invention, are given by way of illustration only, since various changes and modifications within the spirit and scope of the invention will become apparent to those skilled in the art from the detailed description.

### BRIEF DESCRIPTION OF THE DRAWINGS

FIG. 1 is an illustration in perspective of a first measuring tool constructed according to the present invention;

FIG. 2 is an illustration, partly in cross-section, looking toward a side of the measuring tool, as illustrated in FIG. 1; and

FIG. 3 is an illustration of a second measuring tool constructed according to the present invention.

### DESCRIPTION OF PREFERRED EMBODIMENTS

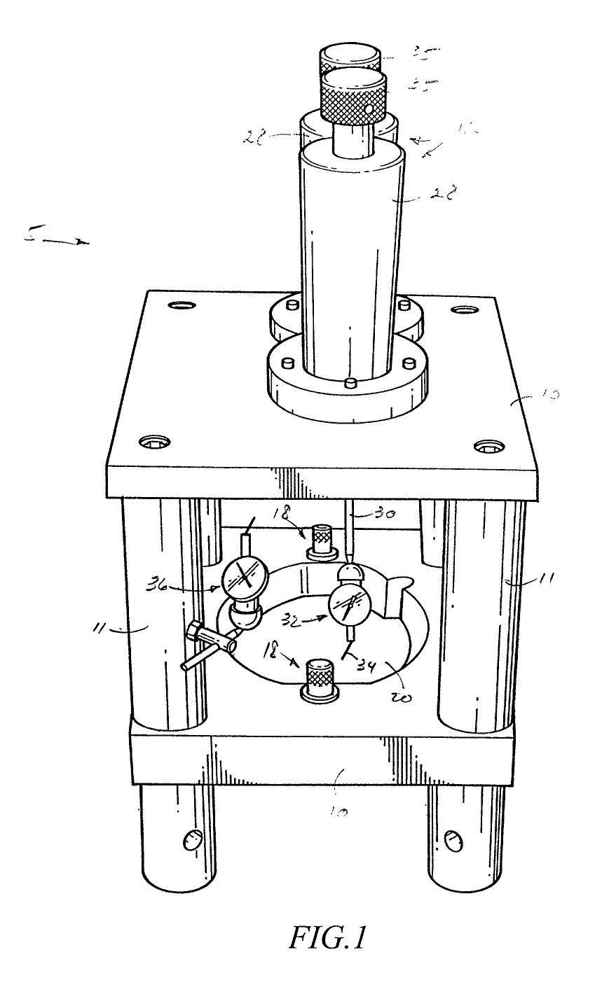

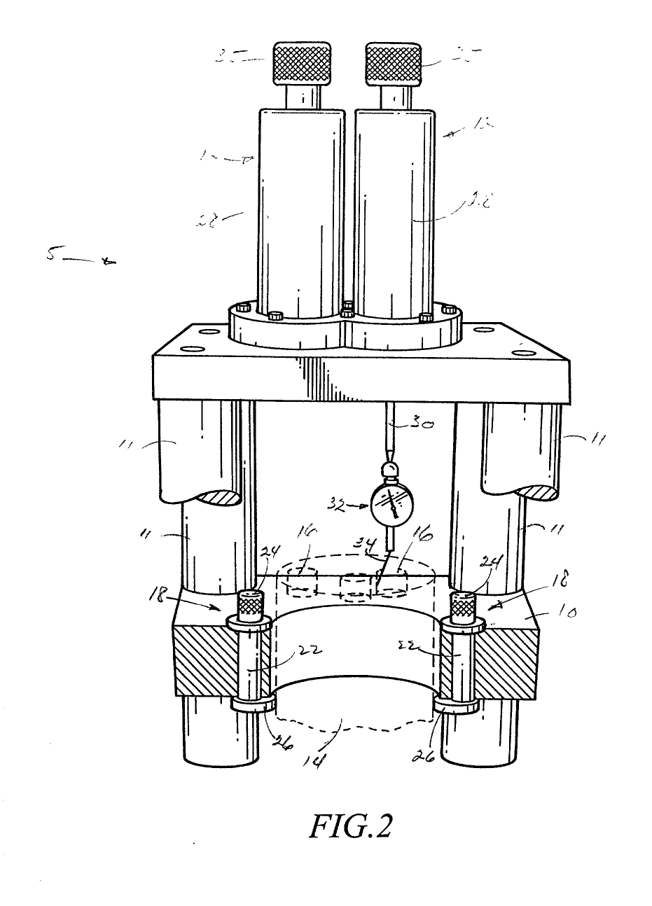

The measuring tool 5 illustrated in FIGS. 1 and 2 includes two platforms 10 separated by risers 11. Two spindle assemblies 12 mounted on the upper platform are located in precise correspondence with the blueprint locations of elements in a machine part 14 to be measured. The material used in the tool may be primarily aluminum, with steel employed at high wear points.

As illustrated, the schematically represented machine part may be a scavenge pump that mounts to the main gearbox of a jet aircraft engine. The scavenge pump has side-by side bores 16, and the measuring tool is particularly adapted for performing measurements of bore location, parallelism and roundness, as well as gear backlash in the scavenge pump. The pump has a mounting surface that mates with a mounting surface or pad on the main gearbox case, whereby elements, such as the bores 16, are properly aligned with elements in the main gearbox to enable a drive transmission from the gearbox to the pump. When installed in the measuring tool, the mounting surface of the pump is fastened to the underside of the lower of the two platforms 12. The lower surface of the lower platform mimics the mounting surface of the main gearbox case. In practice, a dowel on a mounting flange of the pump fits into an opening (not shown) in the underside of the lower platform, to enable the initial location of the pump in the measuring tool.

For precise positioning of the pump in the measuring tool, centering devices 18 are provided at opposite sides of an opening 20 through the lower platform (and displaced about 90° from the dowel opening in the underside of the platform). As best shown in FIG. 2, each of the centering devices includes a pin 22 extending through an opening in the lower platform, a knob 24 fixed to the upper end of the pin and an eccentric head 26, for engagement with the side edge of the pump mounting flange, is fixed to the lower end of the pin. (For purposes of illustration, the eccentricity of the heads is exaggerated in the drawing. In practice the eccentricity is on the order of a few thousandths of an inch.) Indicia (not shown) on the lower platform and on the knobs of the centering devices may be employed for assessing the position of the centering devices from a reference position. The pump can be fastened to the underside of the lower platform by bolts extending through a flange on the pump and into the underside of the lower platform.

Each of the spindle assemblies comprises a hollow column 28 receiving a rotatable spindle shaft 30 that extends through the upper platform toward the lower platform. Each spindle shaft may be supported in the column by a “zero lash” tapered bearing. A dial indicator 32 with a movable probe 34 is fastened to the lower end of the spindle shaft.

With the pump fastened to the lower platform, and the probe of the dial indicator engaging the inside surface of one of the pump bores, a sweep of the probe about the bore is performed by turning the spindle, using a knob 35 located at the top of the column. As the probe sweeps about the bore, deviations of the probe from a reference position will be displayed by the dial indicator. This process is repeated for performing measurements in the other of the pump bores. Index marks (not shown) on the knob and the column allow an assessment of measurement variations at different incremental angular positions of the probe in the pump bore.

As best shown in FIG. 1, a dial indicator 36 mounted on one of the risers of the fixture enables measuring the backlash of the idler gear and/or drive gear in the scavenge pump.

The machine part 14 shown schematically in FIG. 2 may be a reference standard used to calibrate the measuring tool. The standard has a mounting surface precisely corresponding to the mounting surface of the machine part to be measured in the tool. Bores 16 in the standard have dimensions and locations precisely corresponding to the bores in the machine part to be measured. The measuring technique is like the one used to perform measurements on the bores of a pump installed in the measuring tool: with the standard fastened to the lower platform, and the probe of the dial indicator engaging the inside surface of a bore 16, a knob 35 on a spindle assembly is turned to perform a sweep of the probe about the bore. The mounting of the spindle assemblies on the upper platform allows for slight shifting to correct for out-of-specification positions identified by sweeps of the dial indicator probe in the bores of the reference standard.

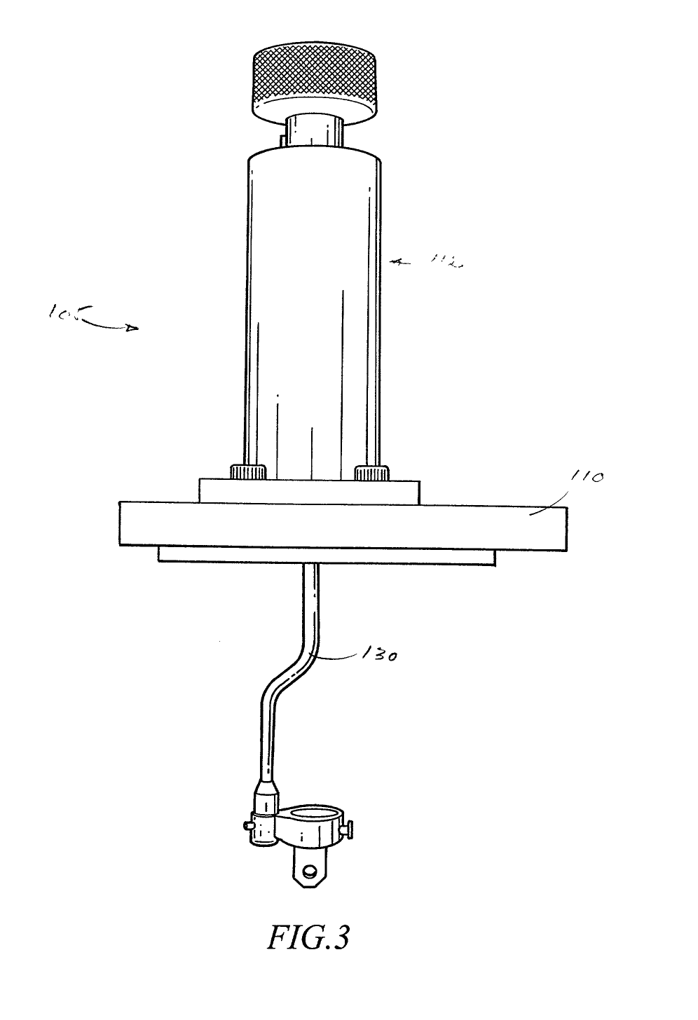

The measuring tool 105 shown in FIG. 3 includes a base 110 with a surface that mimics the mounting flange of a mating machine part. In the illustrated tool, the surface of the base mimics the mounting flange of a scavenge pump employed in a jet aircraft engine. Carried on the base is a spindle assembly 112, which is like the spindle assemblies employed in the measuring tool illustrated in FIGS. 1 and 2. The spindle assembly is located in precise correspondence with the blue print position of a bore in the other of the mating machine parts, in particular the bore in the gearbox case of the jet aircraft engine. Precise lateral positioning of the base on the gearbox case can is ensured by a dowel (not shown) extending from the base into a bore in the pump mounting pad on the gearbox case and by fasteners that join the base to the gearbox case. The movable probe of a dial indicator (not shown) fastened to the spindle shaft 130 of the spindle assembly is swept about the bore in the gearbox case to perform measurements of the location, orientation and dimensions of the bore. If necessary, the tool can be used under wing, without removing the gearbox from the aircraft, to perform measurements of, for example, the idler gear bore within the main gearbox case of a jet aircraft engine.

The measuring tool 105 shown in FIG. 3 can be calibrated using the measuring tool 5 shown in FIGS. 1 and 2. The base 110 of tool 105 is fastened to the underside of the lower platform 10 of tool 5 with the spindle shaft 130 extending upwardly through the opening 20 in the lower platform. With the probe 34 of dial indicator 32 in tool 5 engaging the surface of the spindle shaft 130 of tool 105, a sweep of the probe 34 about the shaft 130 is performed by turning the aligned spindle shaft 30, using knob 35 located at the top of the column 12. As the probe sweeps about the shaft, deviations of the probe from a reference position will be displayed by dial indicator 30.

From the foregoing description it will be apparent that the invention is susceptible to many variations. Such variations are not to be regarded as a departure from the spirit and scope of the invention, and all such modifications as would be obvious to one skilled in the art are intended to be included within the scope of the following claims.

What is claimed is:

1. A measuring tool for performing measurements on a first machine part having a mounting surface that mates with a mounting surface of a cooperating machine part, the tool comprising:
a mounting surface that (1) mimics the mounting surface of the cooperating machine part and (2) has an opening therethrough, whereby the tool can be joined to the first machine part in a position that corresponds to the position of the cooperating machine part when mated with the first machine part, while permitting access to the first machine part;
a spindle assembly including a rotatable spindle shaft that extends toward the opening through the mounting surface of the tool at a location, and at an orientation, corresponding to a desired location and orientation of an element in the first machine part; and
a measuring instrument carried on the spindle shaft, the measuring instrument having a movable probe and an indicator responsive to deviations in the position of the probe from a reference position, whereby turning of the spindle shaft with the probe engaging a surface of the element in the first machine part will provide an indication of deviations of the location, orientation and dimensions of the element from desired values for location, orientation and dimensions of the element.

2. The measuring tool as recited in claim 1, wherein the spindle assembly includes a hollow column in which the spindle shaft is mounted for rotation, and further comprising:
a knob on the spindle shaft for effecting rotary movements of the spindle shaft; and
indicia carried on the column and on the knob for assessing the rotary position of the spindle shaft.

3. The measuring tool as recited in claim 1, and further comprising first and second spaced support members, the mounting surface of the tool being provided on the first support member, and the spindle assembly being supported on the second support member.

4. The measuring tool as recited in claim 3, and further comprising rotary eccentric members supported on the first support member at opposite sides of the opening through the mounting surface of the tool, for effecting precise positioning of the first machine part.

5. The measuring tool as recited in claim 3, and further comprising:
at least one riser member extending between the support members and maintaining the spacing between the support members;
a measuring instrument carried on the riser member, the measuring instrument having a movable probe and an indicator responsive to deviations in the position of the probe from a reference position, whereby, with the probe engaging a rotary element on the first machine part, play of the rotary element can be assessed.

6. The measuring tool as recited in claim 1, wherein:
the element in the first machine part comprises a bore; and
the probe engages the interior surface of the bore during turning of the spindle shaft.

7. The measuring tool as recited in claim 1, wherein the spindle shaft extends through the mounting surface of the tool.

8. A measuring tool for performing measurements on a first machine part having (1) a mounting surface that mates with a mounting surface of a cooperating machine part and (2) a plurality of side-by-side bores accessible through the mounting surface of the first machine part, the tool comprising:
a mounting surface that (1) mimics the mounting surface of the cooperating machine part and (2) has an opening therethrough, whereby the tool can be joined to the first machine part in a position that corresponds to the position of the cooperating machine part when mated with the first machine part, while permitting access to the bore in the first machine part;
a plurality of spindle assemblies, each of the spindle assemblies including a rotatable spindle shaft that extends toward the opening through the mounting surface of the tool at a location, and at an orientation, corresponding to a desired location and orientation of a bore in the first machine part; and
a measuring instrument carried on at least one of the spindle shafts, the measuring instrument having a movable probe and an indicator responsive to deviations in the position of the probe from a reference position, whereby turning of the spindle shaft with the probe engaging the interior surface of a bore in the first machine part will provide an indication of deviations of the location, orientation and roundness of the bore from desired values for location, orientation and roundness of the bore.

9. The measuring tool as recited in claim 8, wherein each spindle assembly includes a hollow column in which the spindle shaft is mounted for rotation, and further comprising:
a knob on the spindle shafts for effecting rotary movements of the spindle shaft; and
indicia carried on the columns and on the knobs for assessing the rotary position of the spindle shaft.

10. The measuring tool as recited in claim 8, and further comprising first and second spaced support members, the mounting surface of the measuring tool being provided on the first support member, and the spindle assembly being supported on the second support member.

11. The measuring tool as recited in claim 10, and further comprising:
at least one riser member extending between the support members and maintaining the spacing between the support members;
a measuring instrument carried on the riser member, the measuring instrument having a movable probe and an indicator responsive to deviations in the position of the probe from a reference position, whereby, with the probe engaging a rotary element on the first machine part, play of the rotary element can be assessed.

12. The measuring tool as recited in claim 8, and further comprising rotary eccentric members supported on the first support member at opposite sides of the opening through the mounting surface of the tool, for effecting precise positioning of the first machine part.

13. A method of performing measurements on a first machine part having a mounting surface that mates with a mounting surface of a cooperating machine part, the method comprising the steps of:
joining a measuring tool to the first machine part in a position that corresponds to the position of the cooperating machine part when mated with the first machine part, the measuring tool including a spindle assembly including (1) a rotatable spindle shaft that extends toward the mounting surface of the tool at a location, and at an orientation, corresponding to a desired location and orientation of an element in the first machine part and (2) a measuring instrument carried on the spindle shaft, the measuring instrument having a movable probe and an indicator responsive to deviations in the position of the probe from a reference position; and
turning the spindle shaft with the probe engaging a surface of the element in the first machine part to thereby obtain an indication of deviations of the location, orientation and dimensions of the element from desired values for location, orientation and dimensions of the element.

14. The method as recited in claim 13, wherein:
the element in the first machine part comprises a bore; and
the probe engages the interior surface of the bore during turning of the spindle shaft.
